(19) United States
(12) Patent Application Publication
(10) Pub. No.: US 2004/0209968 A1
(43) Pub. Date: Oct. 21, 2004

(54) Flame retardant expandable poly(arylene ether)/polystyrene compositions and preparation thereof

(76) Inventors: Jos Bastiaens, Bergen op Zoom (NL); Jan Keulen, Ossendrecht (NL); Adrie Landa, Bergen op Zoom (NL)

Correspondence Address: CANTOR COLBURN, LLP, 55 GRIFFIN ROAD SOUTH, BLOOMFIELD, CT, 06002

(21) Appl. No.: 10/815,267

(22) Filed: Mar. 31, 2004

Related U.S. Application Data
(63) Continuation-in-part of application No. 10/427,278, filed on May 1, 2003, now Pat. No. 6,743,846.
Application No. 10/427,278 is a continuation of application No. 09/681,605, filed on May 7, 2001, now Pat. No. 6,583,205.
(60) Provisional application No. 60/481,095, filed on Jul. 16, 2003.

(51) Int. Cl. C08J 9/00

(52) U.S. Cl. 521/82; 521/85; 521/134

(57) ABSTRACT

A non-halogenated, fire retardant, expanded poly (arylene ether)/polystyrene blends is produced by the method comprising, in a first step, forming a fire retardant mixture comprising a non-halogenated fire retardant, poly(arylene ether) resin and polystyrene resin by intimately mixing in melt; and in a second step, forming the non-halogenated, fire retardant, expandable poly (arylene ether)/polystyrene blend by intimately mixing in melt the fire retardant mixture with a blowing agent and in a third step expanding the non-halogenated, fire retardant, expandable poly (arylene ether)/polystyrene blend.

### CROSS REFERENCE TO RELATED APPLICATIONS

This application is a continuation-in-part of U.S. patent application Ser. No. 10/427,278 filed on May 1, 2003 which is a continuation of U.S. Pat. No. 6,583,205 filed on May 7, 2001 both of which are fully incorporated herein by reference. This application claims the benefit of U.S. Provisional Patent Application Serial No. 60/481,095 filed on Jul. 16, 2003, which is fully incorporated herein by reference.

### BACKGROUND OF THE INVENTION

This invention relates to the field of expandable and expanded poly(arylene ether)/polystyrene compositions.

Expanded thermoplastic compositions (foams) are used in a wide variety of applications. Foams have long been used within the passenger compartments of vehicles as a means for protecting the occupants from injury during a collision. Impact absorbing thermoplastic foams have been applied over hard surfaces within the passenger compartment in order to provide an energy absorbing cushioning layer over the surfaces. The rigid or semi-rigid energy absorbing foams are widely used because they absorb impact energy very efficiently by crushing. These impact absorbing thermoplastic foam layers are usually covered with a decorative layer, such as a fabric layer. The resulting “interior trim” articles therefore serve both as passenger safety devices and as decorative interior surfaces. Such interior trim articles are commonly found in automobiles as headliners, dashboard pads, knee bolsters, and the like. The interior trim articles are usually installed over hard interior surfaces (substrates), particularly metal surfaces. Many different types of interior trim systems are known in the art. Interior trim systems comprising thermoplastic foams are very widely used.

The fit between the thermoplastic foam interior trim part and substrate is rarely perfect and some degree of movement between the trim part and the substrate is inevitable. Slight movement between the trim part and the substrate may take place during operation of the vehicle, as a result of vibrations caused by the road surface, the engine, etc. These movements between the trim panel and the substrate may result in a “squeaking” noise during the operation of the vehicle. This squeaking noise may be sufficiently loud as to be considered unacceptable by the occupants of the vehicle. The squeaking problem can be especially severe when the trim panel is installed over a metal substrate, and may be quite serious even when the metal itself is coated (as, for example, with a primer).

Attempts to ameliorate the squeaking associated with foam interior trim parts have included the application of coatings and sound dampening materials onto the surface of the part that comes into contact with the substrate. However, the introduction of an additional layer requires secondary operation steps in the manufacturing process with corresponding increases in cost and decreases in efficiency.

Squeaking or other undesirable sounds may also occur in building and construction materials, particularly in insulation applications where foam is used to insulate items that are subjected to temperature cycling such as hot pipes. As the result of the continuous heating and cooling cycles, the covering foam expands and contracts causing friction against the fixed, solid parts. This can result in undesirable noise.

In addition it is desirable in some applications for the thermoplastic foam to be flame retardant. In the past it was common for halogenated compounds to be used to provide flame retardance. However halogenated flame retardants may release toxic gas and/or corrosive material when heated to an elevated temperature. Additionally inclusion of a halogenated flame retardant can make the composition non recyclable.

The most widely used process for making expandable poly(arylene ether)/polystyrene is via the styrene suspension polymerization process. Terminally end capped poly(arylene ether) resin is dissolved in the styrene monomer prior to polymerization and polymerization proceeds by the suspension process. During or at the end of polymerization a blowing agent is added. At the end of the process poly(arylene ether)/polystyrene expandable beads are recovered. Terminally endcapped poly(arylene ether) resin is required so the poly(arylene ether) resin does not inhibit the polymerization of the styrene. Unfortunately, the capping agent introduces by products and interferes with polymerization, resulting in low yield. Additionally, the poly(arylene ether) resin has limited solubility in the monostyrene, restricting the amount of poly(arylene ether) resin that can be added to the blend. This, in turn, limits the high temperature properties of the resulting poly(arylene ether)/polystyrene materials. The high viscosity of the composition limits the amount of additives, such as flame retardants and impact modifiers that can be included. Furthermore, only halogenated flame retardants may be used and the variety of colors available in the finished product is limited because the chemical reactor must be extensively cleaned for every color change is to be made. Thus the styrene polymerization process for making expandable poly(arylene ether)/polystyrene has several drawbacks including limited poly(arylene ether) resin solubility, modified poly(arylene ether) resin is required, a halogenated flame retardant is required, and high viscosity and color limitations. These drawbacks limit the potential to manufacture expandable poly(arylene ether)/polystyrene materials with advanced properties through the suspension process. Additionally, expandable poly(arylene ether)/polystyrene materials made by the suspension process exhibit squeaking behavior.

### BRIEF SUMMARY OF THE INVENTION

The above-mentioned draw backs and disadvantages are addressed by a non-halogenated, fire retardant, expanded poly (arylene ether)/polystyrene blend produced by the method comprising, in a first step, forming a fire retardant mixture comprising a non-halogenated fire retardant, poly(arylene ether) resin, polystyrene resin essentially free of plasticizer, and optionally a nucleating agent by intimately mixing in melt; in a second step, forming a non-halogenated, fire retardant, expandable poly (arylene ether)/polystyrene blend by intimately mixing in melt the fire retardant mixture with a blowing agent, and, in a third step, expanding the non-halogenated, fire retardant, expandable poly(arylene ether)/polystyrene blend.

In another embodiment an expanded poly(arylene ether)/polystyrene blend is produced by the method comprising, in a first step, forming a first mixture comprising poly(arylene ether) resin, polystyrene resin essentially free of plasticizer and optionally a nucleating agent by intimately mixing in melt; in a second step forming an expandable poly(arylene ether)/polystyrene blend by intimately mixing in melt the first mixture with a blowing agent and, in a third step, expanding the expandable poly(arylene ether)/polystyrene blend.

In another embodiment an expandable poly(arylene ether)/polystyrene blend comprises poly(arylene ether) resin, polystyrene resin essentially free of plasticizer, a nucleating agent and blowing agent.

In another embodiment a non-halogenated, fire retardant, expandable poly(arylene ether)/polystyrene blend comprises poly(arylene ether) resin, polystyrene resin essentially free of plasticizer, a non-halogenated fire retardant, a nucleating agent and blowing agent.

In another embodiment an expandable poly(arylene ether)/polystyrene blend is produced by the method comprising, in a first step, forming a first mixture comprising poly(arylene ether) resin, polystyrene resin essentially free of plasticizer, and optionally a nucleating agent by intimately mixing in melt; in a second step forming an expandable poly(arylene ether)/polystyrene blend by intimately mixing in melt the first mixture with a blowing agent.

In another embodiment a non-halogenated, fire retardant expandable poly(arylene ether)/polystyrene blend is produced by the method comprising, in a first step, forming a first mixture comprising poly(arylene ether) resin, polystyrene resin essentially free of plasticizer, a non-halogenated fire retardant, and optionally a nucleating agent by intimately mixing in melt; in a second step forming an expandable poly(arylene ether)/polystyrene blend by intimately mixing in melt the first mixture with a blowing agent.

In another embodiment a precursor composition useful in making an expandable poly(arylene ether)/polystyrene composition comprises poly(arylene ether) resin, a polystyrene resin essentially free of plasticizer, a nucleating agent and an optional non-halogenated fire retardant.

The above discussed and other features and advantages will be appreciated and understood by those skilled in the art from the following detailed description.

### DESCRIPTION OF THE DRAWINGS

FIGS. 1 and 2 are electron microscopy images of expanded foams as discussed in Example 7 and Comparative Example 7.

### DETAILED DESCRIPTION OF THE PREFERRED EMBODIMENTS

An expanded poly (arylene ether)/polystyrene blend is produced by the method comprising, in a first step, forming a first mixture comprising an optional non-halogenated fire retardant, a poly(arylene ether) resin, a polystyrene resin, and optional impact modifier by intimately mixing in melt; in a second step, forming the expandable poly (arylene ether)/polystyrene blend by intimately mixing in melt the first mixture with a blowing agent, and, in a third step, expanding the expandable poly (arylene ether)/polystyrene blend. In one embodiment the first mixture further comprises a nucleating agent and in another embodiment a nucleating agent is added to the first mixture during the second step. When the composition comprises a non-halogenated fire retardant it may be referred to as a non-halogenated, fire retardant composition.

Preferably the first step is performed in a first extruder and the second step is performed in a tandem extruder comprising extruder A and extruder B. Intimate mixing of the first mixture and blowing agent to form an expandable poly (arylene ether)/polystyrene blend occurs in extruder A of the tandem extruder and cooling of the expandable poly (arylene ether)/polystyrene blend occurs in extruder B of the tandem extruder. Cooling of the expandable poly (arylene ether)/polystyrene blend prevents premature foaming of the blend at the die. The expandable poly(arylene ether)/polystyrene blend is substantially (greater than 99%) unfoamed. Expressed another way the expandable poly(arylene ether)/polystyrene blend essentially the same density as a comparable composition free of blowing agent.

The expandable poly(arylene ether)/polystyrene blend may be stored as pellets and-then expanded (foamed) or expanded immediately. In one embodiment, the expandable blend is in the form of pellets which may be subjected to an expansion step in which they are expanded to a desired density (pre-expanded) and then shaped (foam molded) to the desired shape. Foam molding may result in the desired article or the shaped expanded blend may be further processed by trimming or other known processes. In another embodiment, the expandable blend is expanded and shaped in a single step.

The expanded poly (arylene ether)/polystyrene blends exhibit excellent molding performance and when a non-halogenated fire retardant is present, excellent fire retardant properties at various thicknesses while maintaining desirable heat dimensional stability. Surprisingly, the non-halogenated, fire retardant, expanded poly (arylene ether)/polystyrene blends exhibit better fire retardant properties, namely short flame out time and non flaming drip behavior, than conventional halogenated, fire retardant, expanded poly (arylene ether)/polystyrene blends. The non-halogenated, fire retardant, expanded poly (arylene ether)/polystyrene blends can achieve an HBF rating or better in the UL ASTM D 4986/ISO/DIS 9772.3 flammability test, something not previously seen in an expanded poly(arylene ether)/polystyrene blend. The excellent fire retardant properties are unexpected and are believed to be the result of the thorough distribution of the non-halogenated fire retardant throughout the expanded poly(arylene ether)/polystyrene blend. The non-halogenated, fire retardant, expanded poly (arylene ether)/polystyrene blends do not require specially end capped poly(arylene ether) resin, have on line processability, can be colored to a wide range of colors and have a wide range of thermal properties.

An additional advantage of the method to produce poly(arylene ether)/polystyrene blends herein described is the ability to incorporate significantly larger amounts of poly(arylene ether) into the blend than currently possible using the suspension polymerization process. As previously mentioned poly(arylene ether) has limited solubility in mono styrene thus restricting the amount of poly(arylene ether) present in a poly(arylene ether)/polystyrene blend produced by suspension polymerization. In contrast, the method herein described can incorporate about 25 weight percent (wt %) of poly(arylene ether) or greater, preferably about 40 wt % or greater or even more preferably about 50 wt % or greater, based on the weight of the composition.

Another advantage of the non-halogenated, fire retardant expanded poly(arylene ether)/polystyrene blend is that the expanded blend exhibits little or no squeaking, thereby potentially eliminating the need for extra manufacturing steps such as applying a coating when making an interior trim part. The non-halogenated, fire retardant expanded poly(arylene ether)/polystyrene blend produces a sound level less than or equal to about 60 decibels when the skin surface of a 2.5 cubic centimeter sample is rubbed across a clear coated test panel with a constant pressure of about 2-2.5 kilo Pascals.

As used herein the term “non-halogenated” is defined as containing less than about 1 weight percent (wt %), preferably less than or equal to about 0.5 wt % and more preferably less than or equal to about 0.2 wt % of chlorine, bromine or a combination of chlorine and bromine, based on the total weight of the composition.

The term poly(arylene ether) includes polyphenylene ether (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like. Poly(arylene ether)s per se, are known polymers comprising a plurality of structural units of the formula (I):

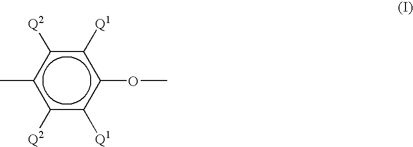

wherein for each structural unit, each Q¹ is independently halogen, primary or secondary lower alkyl (e.g., alkyl containing up to 7 carbon atoms), phenyl, haloalkyl, aminoalkyl, hydrocarbonoxy, halohydrocarbonoxy wherein at least two carbon atoms separate the halogen and oxygen atoms, or the like; and each Q² is independently hydrogen, halogen, primary or secondary lower alkyl, phenyl, haloalkyl, hydrocarbonoxy, halohydrocarbonoxy wherein at least two carbon atoms separate the halogen and oxygen atoms, or the like. Preferably, each Q¹ is alkyl or phenyl, especially C₁₋₄ alkyl, and each Q² is hydrogen.

Both homopolymer and copolymer poly(arylene ether) are included. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles and formals undergo reaction in known manner with the hydroxy groups of two poly(arylene ether) chains to produce a higher molecular weight polymer. Poly(arylene ether)s may further include combinations comprising at least one of the above.

The poly(arylene ether) generally has a number average molecular weight of about 3,000-40,000 atomic mass units (amu) and a weight average molecular weight of about 20,000-80,000 amu, as determined by gel permeation chromatography. The poly(arylene ether) may have an intrinsic viscosity of about 0.10 to about 0.60 deciliters per gram (dl/g), preferably about 0.29 to about 0.48 dl/g, as measured in chloroform at 25° C. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

The poly(arylene ether) are typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

Particularly useful poly(arylene ether) for many purposes are those which comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90% by weight of the polymer, may contain at least one of said aminoalkyl-containing and 4-hydroxybiphenyl end groups.

It will be apparent to those skilled in the art from the foregoing that the contemplated poly(arylene ether) includes many of those presently known, irrespective of variations in structural units or ancillary chemical features. Poly(arylene ether) resin is present in an amount of about 5 weight percent (wt %) to about 95 wt % based on the weight of the composition, preferably about 30 wt % to about 60 wt % based on the weight of the composition.

The term polystyrene as used herein includes polymers prepared by methods known in the art including bulk, suspension and emulsion polymerization, which contain at least 25% by weight of structural units derived from a monomer of formula (II)

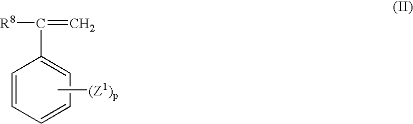

wherein R⁸ is hydrogen, lower alkyl or halogen; Z¹ is vinyl, halogen or lower alkyl; and p is from 0 to about 5. These resins include homopolymers of styrene, chlorostyrene and vinyltoluene, random copolymers of styrene with one or more monomers illustrated by acrylonitrile, butadiene, alpha -methylstyrene, ethylvinylbenzene, divinylbenzene and maleic anhydride, and rubber-modified polystyrene resins comprising blends and grafts, wherein the rubber is a polybutadiene or a rubbery copolymer of about 98-70% styrene and about 2-30% diene monomer. Polystyrene resins are known to be miscible with poly(arylene ether) resin in all proportions, and any such blend may contain polystyrene resin in amounts of about 5 wt % to about 95 wt % and preferably about 40 wt % to about 70 wt %, based on the weight of the composition.

In some embodiments the polystyrene has a molecular weight less than or equal to about 240,000 atomic mass units (AMU) and/or is essentially free of a plasticizer. Essentially free is defined herein as plasticizer content less than 0.1 weight percent based on the total weight of the polystyrene. The molecular weight of the polystyrene is determined by size exclusion chromatography (SEC) or gel permeation chromatograph (GPC). The term “plasticizer” when used in conjunction with polystyrene generally refers to hydrocarbons having about 20 to about 50 carbons and mixtures of hydrocarbons having about 20 to about 50 carbons. An exemplary plasticizer is mineral oil. The plasticizer content of the polystyrene may be determined by nuclear magnetic resonance spectroscopy (NMR) or other methods known in the art. Huntsman 2114, available from GE Advanced Materials, Plastics, is a commercially available material that has both low molecular weight and is essentially free of plasticizer.

Without being bound by theory it is believed that use of a low molecular weight polystyrene allows the use of a lower melt temperature during the introduction of the blowing agent thus improving blowing agent retention in the blend. Similarly the absence of or low level of plasticizer is believed to improve blowing agent retention by increasing blowing agent solubility in the blend.

Nucleating agents are organic or inorganic particulate materials which functions to induce bubble formation during expansion of the expandable material. Exemplary nucleating agents include non-elastomeric polyolefins as taught in U.S. Pat. No. 6,113,822 ground glass, talc, carbon black and metal stearates such as zinc stearate. Typically polyolefins that are used as nucleating agent in foamable products are characterized as high purity, linear, low molecular weight polyethylenes with high level of crystallinity. Exemplary number average molecular weights for the crystalline low molecular weight polyethylenes are about 400 to about 3000 as determined by vapor pressure osmosis. Importantly the nucleating agent is stable at the processing temperatures employed in making the expandable and expanded blends.

Nucleating agents are typically present in an amount of about 0.05 weight percent to about 2 weight percent, based on the total weight of the blend. When an impact modifier is present the amount of nucleating may be about 0.5 weight percent to about 2.0 weight percent, or more specifically, about 1 weight percent to about 1.5 weight percent. When no impact modifier is present the amount of the nucleating agent may be about 0.05 weight percent to about 1.0 weight percent, or, more specifically, about 0.1 weight percent to about 0.5 weight percent.

Suitable non-halogenated flame retardants are organic phosphates, preferably an aromatic phosphate compound of the formula (III):

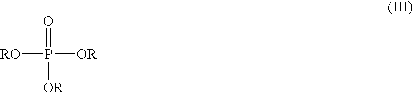

where R is the same or different and is alkyl, cycloalkyl, aryl, alkyl substituted aryl, halogen substituted aryl, aryl substituted alkyl, halogen, or a combination of any of the foregoing, provided at least one R is aryl.

Examples include phenyl bisdodecyl phosphate, phenylbisneopentyl phosphate, phenyl-bis (3,5,5′-tri-methyl-hexyl phosphate), ethyldiphenyl phosphate, 2-ethyl-hexyldi(p-tolyl) phosphate, bis-(2-ethylhexyl) p-tolylphosphate, tritolyl phosphate, bis-(2-ethylhexyl) phenyl phosphate, tri-(nonylphenyl) phosphate, di (dodecyl) p-tolyl phosphate, tricresyl phosphate, triphenyl phosphate, dibutylphenyl phosphate, 2-chloroethyldiphenyl phosphate, p-tolyl bis(2,5,5′-trimethylhexyl) phosphate, 2-ethylhexyldiphenyl phosphate, and the like. The preferred phosphates are those in which each R is aryl.

Alternatively, the organic phosphate can be a di- or polyfunctional compound or polymer having the formula (IV), (V), or (VI) below:

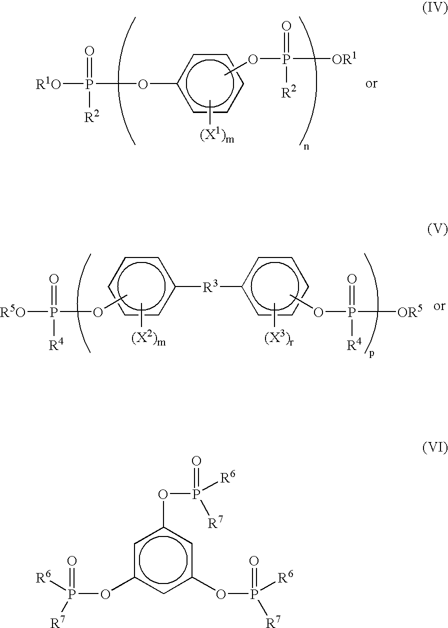

including mixtures comprising at least one of the foregoing compounds, in which R¹, R³ and R⁵ are, independently, hydrocarbon; R², R⁴, R⁶ and R⁷ are, independently, hydrocarbon or hydrocarbonoxy; X¹, X² and X³ are halogen; m and r are 0 or integers from 1 to 4, and n and p are from 1 to 30.

Examples include the bis diphenyl phosphates of resorcinol, hydroquinone and bisphenol-A, respectively, or their polymeric counterparts.

Methods for the preparation of the aforementioned di- and polyfunctional aromatic phosphates are described in British Patent No. 2,043,083.

Another development is the use of certain cyclic phosphates, for example, diphenyl pentaerythritol diphosphate, as a flame retardant agent for polyphenylene ether resins, as is described by Axelrod in U.S. Pat. No. 4,154,775.

Also suitable as flame-retardant additives are compounds containing phosphorus-nitrogen bonds, such as phosphorus ester amides, phosphoric acid amides, and phosphonic acid amides, phosphinic acid amides, and tris(aziridinyl) phosphine oxide.

Preferred phosphate flame retardants include those based upon resorcinol such as, for example, resorcinol tetraphenyl diphosphate, as well as those based upon bis-phenols such as, for example, bis-phenol A tetraphenyl diphosphate. Phosphates containing substituted phenyl groups are also preferred. In one embodiment, the organophosphate comprises butylated triphenyl phosphate ester, resorcinol tetraphenyl diphosphate, bis-phenol A tetraphenyl diphosphate, or a mixture of two or more of the foregoing.

The flame retardant is present in an amount sufficient to impart a degree of flame retardancy to the composition to achieve a HBF rating or better in the UL ASTM D 4986/ISO/DIS 9772.3 test for 12 mm thickness bars. The particular amount will vary, depending on the molecular weight of the organic phosphate, the amount of the flammable resin present and possibly other normally flammable ingredients that might also be included in the composition. Typically the amount of flame retardant is in the range of about 2 wt % to about 25 wt % and preferably about 5 wt % to about 20 wt % based on the weight of the composition.

In general, useful blowing agents are volatile liquids and include but are not limited to aliphatic hydrocarbons, straight chain or branched, with up to 10 carbons; ketones such as acetone and methylethylketone; short chain alcohols such as alcohols having up to 10 carbons; and cycloaliphatic hydrocarbons. Preferred blowing agents are all pentane isomers and mixtures of pentane isomers. An especially preferred blowing agent is n-pentane. Blowing agents are typically used in amounts of about 2 wt % to about 20 wt % based on the weight of the composition, with about 2 wt % to about 10 wt % preferred based on the weight of the composition.

Particularly suitable impact modifiers are the so called block copolymers, for example, A-B-A triblock copolymers and A-B diblock copolymers. The A-B and A-B-A type block copolymer rubber additives which may be used are thermoplastic rubbers comprised of one or two alkenyl aromatic blocks which are typically styrene blocks and a rubber block, e.g., a butadiene block which may be partially hydrogenated. Mixtures of these triblock copolymers and diblock copolymers are especially useful. All impact modifiers generally used for compositions comprising a poly(arylene ether) resin, a polystyrene or a combination of a poly(arylene ether) resin and a polystyrene can be used.

Suitable A-B and A-B-A type block copolymers are disclosed in, for example, U.S. Pat. Nos. 3,078,254, 3,402,159, 3,297,793, 3,265,765, and 3,594,452 and U.K. Patent 1,264,741. Examples of typical species of A-B and A-B-A block copolymers include polystyrene-polybutadiene (SBR), polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(α-methylstyrene)-polybutadiene-poly(α-methylstyrene), as well as the hydrogenated versions thereof, and the like. Mixtures comprising at least one of the aforementioned block copolymers are also useful. Such A-B and A-B-A block copolymers are available commercially from a number of sources, including Phillips Petroleum under the trademark SOLPRENE, Shell Chemical Co., under the trademark KRATON, Dexco under the tradename VECTOR, and Kuraray under the trademark SEPTON.

A useful amount of impact modifier is up to about 30 wt % based on the weight of the composition, with about 1 wt % to about 15 wt % based on the weight of the composition preferred. In an especially preferred embodiment, the impact modifier comprises a polystyrene-polybutadiene-polystyrene block copolymer.

Expanded and expandable poly(arylene ether)/polystyrene blends can also include effective amounts of at least one additive. Possible additives include anti-oxidants; drip retardants; coating additives; dyes; pigments; colorants; stabilizers; antistatic agents; lubricants; mold release agents; and mixtures comprising at least one of the foregoing additives. Effective amounts of the additives vary widely, but they are usually present in an amount up to about 50% by weight, based on the weight of the entire composition.

The non-halogenated, fire retardant, expandable poly (arylene ether)/polystyrene blends are formed by intimately mixing poly(arylene ether) resin, polystyrene resin essentially free of plasticizers, and optional impact modifier in melt with a non-halogenated fire retardant to form a fire retardant mixture. In one embodiment the poly(arylene ether) resin, polystyrene resin, and optional impact modifier are melted and mixed and the non-halogenated fire retardant is then added and intimately mixed to form a fire retardant mixture. The nucleating agent is preferably added with the components of the fire retardant mixture although it may be added with the blowing agent. All mixing equipment capable of mixing in melt may be used although an extruder is preferred. Use of an extruder for the formation of the fire retardant mixture appears to enhance the distribution of the non-halogenated fire retardant. Without being bound by theory, it is believed that even distribution of the non-halogenated fire retardant allows the non-halogenated, fire retardant, expanded mixture to achieve an HBF rating or better in the UL ASTM D 4986/ISO/DIS 9772.3 flammability test. The fire retardant poly(arylene ether)/polystyrene mixture is then mixed in melt with a blowing agent, preferably in a tandem extruder, and cooled. Use of a tandem extruder for melt mixing the fire retardant mixture with the blowing agent to form the non-halogenated, fire retardant, expandable poly (arylene ether)/polystyrene blend allows the melt mixing to occur in extruder A of the tandem extruder and cooling of the blend to occur in extruder B of the tandem extruder thereby preventing premature devolatization of the blowing agent at the extruder die.

The expandable poly(arylene ether)/polystyrene blends are formed by intimately mixing poly(arylene ether) resin, polystyrene resin essentially free of plasticizers, and optional impact modifier in melt to form a precursor mixture. In one embodiment the poly(arylene ether), polystyrene resin, and optional impact modifier are independent components. All mixing equipment capable of mixing in melt may be used although an extruder is preferred. Use of an extruder for the formation of the precursor mixture appears to enhance the distribution of the nucleating agent. The nucleating agent is preferably added with the components of the precursor mixture although it may be added with the blowing agent. Without being bound by theory, it is believed that even distribution of the nucleating agent results in better nucleation during expansion which results in a finer and more regular cell structure in the expanded material. The precursor mixture is then mixed in melt with a blowing agent, preferably in a tandem extruder, and cooled. Use of a tandem extruder for melt mixing the precursor mixture with the blowing agent to form the expandable poly (arylene ether)/polystyrene blend allows the melt mixing to occur in extruder A of the tandem extruder and cooling of the blend to occur in extruder B of the tandem extruder thereby preventing premature devolatization of the blowing agent at the extruder die.

The expandable poly(arylene ether)/polystyrene blend and the fire retardant expandable poly(arylene ether)/polystyrene blend can be expanded, typically by the exposure to heat, to form an expanded (foamed) material. The expanded material may have a density greater than or equal to 20 kilograms per cubic meters. Once expanded, the expanded blend can be shaped into the desired form. The expanded fire retardant poly(arylene ether)/polystyrene blend exhibits little or no squeaking when rubbed across a substrate. This characteristic, combined with other properties such as flame resistance, molding performance, and heat dimensional stability make the expanded fire retardant material ideal for use in a range of applications, particularly those in which low squeak in valued. Examples of low squeak applications include automobile interior trim articles, railroad interior trim articles, airplane interior trim articles, marine interior trim articles and insulation applications where expansion and contraction result in squeaking such as pipe insulation. Examples of automobile interior trim articles, railroad interior trim articles, airplane interior trim articles, and marine interior trim articles include door panels, knee bolsters, instrument panels, wedges for groundsheets, roof padding, headrests, and armrests.

The invention is further illustrated by the following non-limiting examples.

### EXAMPLES

The materials used in the following examples are listed in Table 1.

TABLE 1

| | Source and/or | |
|---|---|---|
| Material | Trade Name | Properties |
| Poly(arylene | GE Plastics/PPO ® | I.V. = 32 ml/gram at 25° C. |
| ether) | | in toluene |
| Polystyrene | GE/Huntsman 2114 | MW = 206,000 |
| Impact Modifier | Kraton Shell/D-1102 | — |
| (SBS) | | |
| Flame retardant | Daihachi Chemical/RDP | — |

The comparative example was formed using NORYL® EF, commercially available from GE Plastics. NORYL® EF is a poly(arylene ether)/polystyrene blend with hexabromocyclododecane (HBCD) as a flame retardant. The formulation of NORYL® EF is shown in Table 2.

Examples 1, 2, and 3 were made according to the formulations shown in Table 2 using a ZSK28 twinscrew extruder from Werner & Pfleiderer. The Comparative Example employs polystyrene resulting from a suspension process which does not contain polybutadiene. The polystyrene in Examples 1-3 contains polybutadiene. In Examples 2 and 3, the poly(arylene ether) resin and polystyrene resin were added, using different feeders, to the extruder. In Example 1 the polystyrene resin was split fed, about 46% of the polystyrene resin was added with the poly(arylene ether) resin and the remainder was added by a separate feeder. The resorcinol diphosphate was added by a liquid injection pump after the addition of the polystyrene was complete. In Example 3 the impact modifier (SBS) was added with the poly(arylene ether) as a mixture. The melt temperature was in the range of about 301° C. to about 311° C. Temperatures after melt were in the range of about 210° C. to about to about 270° C. The examples were then direct gassed in a tandem extruder with pentane.

TABLE 2

| | | | | Comparative |
|---|---|---|---|---|
| Material | 1 | 2 | 3 | Example |
| Poly(arylene ether) | 30 | 50 | 40 | 10 |
| Polystyrene | 65 | 35 | 35 | 90 |
| Impact modifier | — | — | 15 | — |
| Resorcinol Diphosphate | 5 | 15 | 10 | — |
| HBCD | — | — | — | 1.5 |
| Pentane | 6 | 6 | 6 | 6 |

Total composition: poly(arylene ether) + polystyrene + impact modifier (when present) + resorcinol diphosphate = 100 wt %.

Pentane content is expressed in parts by weight per 100 parts by weight of total composition (poly(arylene ether), polystyrene, optional impact modifier, resorcinol diphosphate, and pentane).

The examples were foam molded into 12 millimeter thickness bars and 6 millimeter thickness bars for testing for flammability according to UL ASTM 4986/ISO/DIS 9772.3, a horizontal burning test for foamed materials. This flammability test rates performance in the following manner: non-classified (NC) which is the worst flaming behavior, medium flame retardant performance (HBF), and superior flame retardant performance (HF1). Superior flame retardant performance is defined as short flame out times and non dripping behavior. The 12 mm bars were examined for molding quality and heat dimensional stability. Molding quality is expressed in terms of the degree of fusion at the surface of a molded part and at the fracture of a broken part. Heat dimensional stability is the temperature at which the shrinkage of the molded part heated in an air circulated oven is less than 1%. The results are shown in Table 3. Values in brackets are for 6 mm bars.

TABLE 3

| | | | | Compara- |
|---|---|---|---|---|
| | | | | tive |
| Properties | 1 | 2 | 3 | Example |
| Molding quality | Excellent | Good | Good | Excellent |
| Heat Dimensional Stability | 104 | 104 | 104 | 105 |
| in ° C. | | | | |
| Average flame out time in | 33.3 [2.0] | 0 [0] | 24.8 [7.6] | 32 [11.6] |
| seconds | | | | |
| Dripping (% out of 5 bars) | 0 | 0 | 0 | 100 |
| UL Rating | HBF | HF1 | HBF | NC |
| | [HBF] | [HF1] | [HBF] | [HBF] |

While the non-halogenated, expandable, fire retardant poly(arylene ether)/polystyrene blends, (Examples 1, 2, and 3) show comparable molding quality and heat dimensional stability to prior art material (Comparative Example), they show marked improvement in dripping, average flame out time and UL rating. Thus the non-halogenated, expandable, fire retardant poly(arylene ether)/polystyrene blends not only improve upon the properties of available flame retardant poly(arylene ether)/polystyrene blends but they have the added advantages of being non-halogenated and producible in an efficient, cost effective, on line manner.

Several expanded materials were tested for squeaking behavior. Comparative Example (C.E.) 2 is an expanded polystyrene. Comparative Example 3 is an expanded poly(arylene ether)/polystyrene blend made by the suspension process having 30 parts by weight poly(arylene ether ) and 70 parts by weight polystyrene made from an expandable material commercially available from GE Plastics under the tradename Noryl EF 350R. Comparative Example 4 is an expanded fire retardant poly(arylene ether)/polystyrene blend made by melt blending with the blowing agent added in a pressurized vessel after pelletization. The material is commercially available under the tradename Gecet F100 from Fagerdala. Comparative Example 5 is an expanded polypropylene material. Comparative Example 6 is an expanded polyurethane material. The compositions of Examples 4-6 are shown in Table 4. Examples 4-6 additionally contain black pigment and 0.2% of a nucleating agent known under the commercial name Polywax 2000 and supplied by Baker Petrolite.

TABLE 4

| Material | 4 | 5 | 6 |
|---|---|---|---|
| Poly(arylene ether) | 30 | 37 | 54.2 |
| Polystyrene | 62.5 | 53 | 16.8 |
| Impact modifier | — | — | 15 |
| Resorcinol Diphosphate | 7.5 | 10 | 14 |

Total composition: poly(arylene ether) + polystyrene + impact modifier (when present) + resorcinol diphosphate = 100 wt %.

The Comparative Examples and Examples 4-6 were tested for squeaking behavior by rubbing a 5 centimeter (cm) by 2 cm block of material along a 30 cm path of glass. Each example was rubbed on a fresh pathway of glass. The amount of squeaking was rated on a scale of 1 (most severe squeaking) to 5 (least or no squeaking). Comparative Example 2, known in the art to exhibit severe squeaking, was tested first and employed as the benchmark to establish the amount of squeak correlation to a ranking of 1. The test was performed by six different operators. Results are shown in Table 5.

TABLE 5

| | | | | | | | | Std |
|---|---|---|---|---|---|---|---|---|
| Example | Op. 1 | Op. 2 | Op. 3 | Op. 4 | Op. 5 | Op. 6 | Avg. | Dev. |
| C.E. 2 | 1 | 1 | 1 | 1 | 1 | 1 | 1 | 0 |
| C.E. 3 | 1 | 1 | 2 | 2 | 1 | 2 | 2 | 1.55 |
| C.E. 4 | 3 | 2 | 3 | 4 | 3 | 2 | 2.8 | 0.75 |
| C.E. 5 | 2 | 3 | 1 | 1 | 1 | 1 | 1.2 | 0.4 |
| C.E. 6 | 5 | 5 | 5 | 5 | 5 | 5 | 5 | 0 |
| 4 | 2 | 1 | 4 | 3 | 2 | 4 | 2.7 | 1.2 |
| 5 | 4 | 4 | 5 | 4 | 4 | 4 | 4.2 | 0.4 |
| 6 | 5 | 5 | 4 | 5 | 2 | 2 | 4.7 | 0.5 |

Comparative Examples 2-6 and Examples 4 and 6 were further tested for squeak by rubbing the skin surface of a 2.5 cubic centimeter foam sample across a test panel with a constant pressure of 2-2.5 kilo Pascals for a specified period of time. The test panel was coated with an automotive clearcoat (RK8010A available from DuPont). The average amount of sound produced was measured. The average sound levels are expressed in decibels (dBa) in Table 6.

TABLE 6

| Example | Average sound level (dBa) |
|---|---|
| C.E. 2 | 64.7 |
| C.E. 3 | 72.2 |
| C.E. 4 | 65.5 |
| C.E. 5 | 23.8 |
| C.E. 6 | 27.9 |
| 4 | 59.7 |
| 6 | 56.5 |

As can be seen by the foregoing examples, the expanded fire retardant poly(arylene ether)/polystyrene material produced by the method described herein exhibited less squeak than other polystyrene or poly(arylene ether)/polystyrene expanded materials.

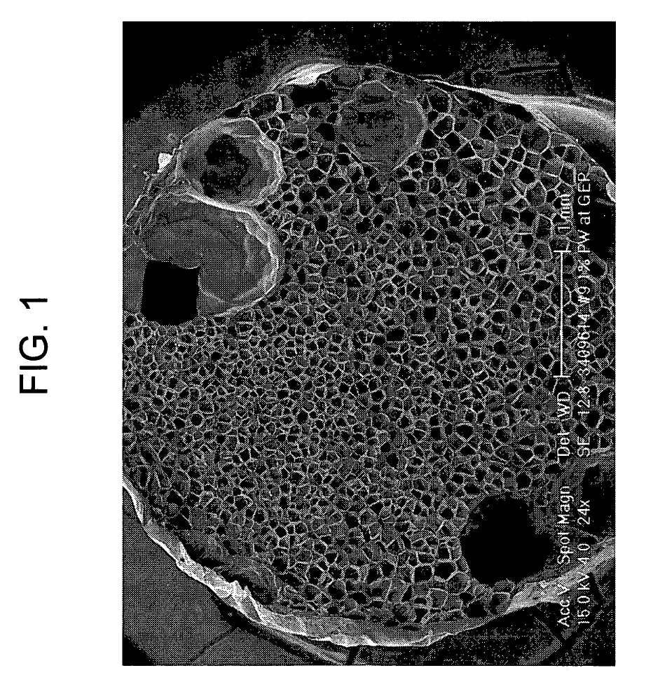

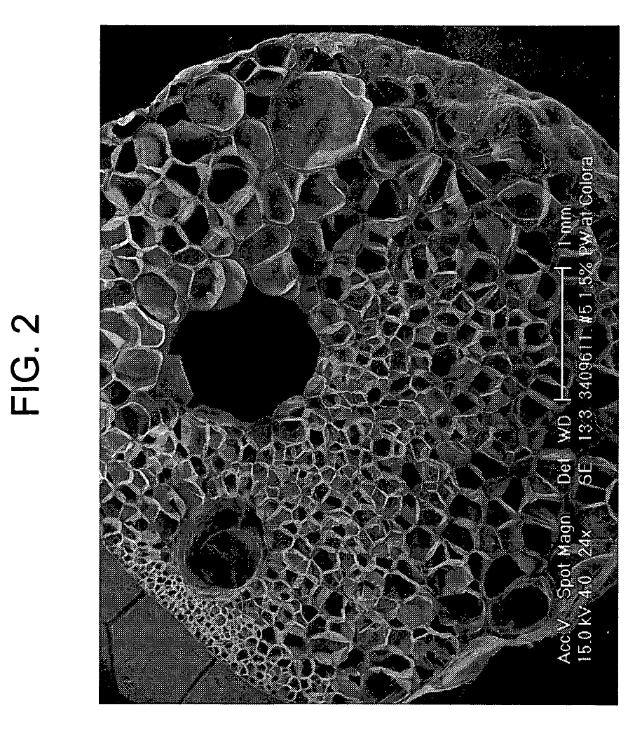

Example 7 was produced by blending 40 weight percent poly(arylene ether), 35 weight percent polystyrene having a molecular weight of about 210,000 and less than 0.1 weight percent plasticizer, 10 weight percent of resorcinol diphosphate, 15 weight percent of an impact modifier and 1 weight percent of a nucleating agent (Polywax 2000) in melt to form a precursor blend which was pelletized. The pelletized precursor was then melt mixed with a blowing agent to form an expandable blend. The expandable blend was expanded by exposure to hot steam. The expanded material was examined be electron microscopy. An electron microscopy image is shown in FIG. 1. Comparative Example 7 employed the same materials in the same amounts and was prepared by the same method with the difference being that 1.5 weight percent nucleating agent was added in the same step as the blowing agent. An electron microscopy image of comparative Example 7 is shown in FIG. 2. As can be seen by FIGS. 1 and 2 the addition of nucleating agent during the first melt mixing step results in a finer cell structure and a more regular distribution of the cell diameter than addition of the nucleating agent during the second melt mixing step.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All patents cited herein are incorporated by reference.

1. A non-halogenated, fire retardant, expanded poly (arylene ether)/polystyrene blend produced by the method comprising:
in a first step, forming a fire retardant mixture comprising a non-halogenated fire retardant, poly(arylene ether) resin, and a polystyrene resin essentially free of plasticizer by intimately mixing in melt;
in a second step, forming a non-halogenated, fire retardant, expandable poly (arylene ether)/polystyrene blend by intimately mixing in melt the fire retardant mixture with a blowing agent; and
in a third step, expanding the non-halogenated, fire retardant, expandable poly(arylene ether)/polystyrene blend.

2. The non-halogenated, fire retardant, expanded poly (arylene ether)/polystyrene blend of claim 1 wherein the blend produces a sound level less than or equal to about 60 decibels when the skin surface of a 2.5 cubic centimeter sample is rubbed across a clear coated test panel with a constant pressure of about 2-2.5 kilo Pascals.

3. The non-halogenated, fire retardant, expanded poly (arylene ether)/polystyrene blend of claim 1 wherein the poly(arylene ether) has an intrinsic viscosity of about 0.1 to about 0.6 deciliters per gram as measured in chloroform at 25° C.

4. The non-halogenated, fire retardant, expanded poly (arylene ether)/polystyrene blend of claim 1 wherein the poly(arylene ether) is present in an amount of about 5 to about 95 weight percent, based on the weight of the composition and the amount of polystyrene is about 5 to about 95 weight percent, based on the weight of the composition.

5. The non-halogenated, fire retardant, expanded poly (arylene ether)/polystyrene blend of claim 1 wherein the polystyrene has a molecular weight less than or equal to about 240,000 atomic mass units.

6. The non-halogenated, fire retardant, expanded poly (arylene ether)/polystyrene blend of claim 1 wherein the fire retardant mixture further comprises a nucleating agent.

7. The non-halogenated, fire retardant, expanded poly (arylene ether)/polystyrene blend of claim 1, wherein the fire retardant mixture further comprises an impact modifier.

8. The non-halogenated, fire retardant, expanded poly (arylene ether)/polystyrene blend of claim 1, wherein the non-halogenated fire retardant comprises butylated triphenyl phosphate ester, resorcinol tetraphenyl diphosphate, bis-phenol A tetraphenyl diphosphate, or a mixture of two or more of the foregoing.

9. The non-halogenated, fire retardant, expanded poly (arylene ether)/polystyrene blend of claim 1, wherein the blowing agent comprises a pentane isomer or a mixture of pentane isomers.

10. An expanded poly(arylene ether)/polystyrene blend produced by the method comprising:
in a first step, forming a first mixture comprising poly(arylene ether) resin, and polystyrene resin essentially free of plasticizer by intimately mixing in melt;
in a second step forming an expandable poly(arylene ether)/polystyrene blend by intimately mixing in melt the first mixture with a blowing agent; and
in a third step, expanding the expandable poly(arylene ether)/polystyrene blend.

11. The expanded poly (arylene ether)/polystyrene blend of claim 10 wherein the poly(arylene ether) has an intrinsic viscosity of about 0.1 to about 0.6 deciliters per gram as measured in chloroform at 25° C.

12. The expanded poly (arylene ether)/polystyrene blend of claim 10 wherein the poly(arylene ether) is present in an amount of about 5 to about 95 weight percent, based on the weight of the composition and the amount of polystyrene is about 5 to about 95 weight percent, based on the weight of the composition.

13. The expanded poly (arylene ether)/polystyrene blend of claim 10 wherein the polystyrene has a molecular weight less than or equal to about 240,000 atomic mass units.

14. The expanded poly (arylene ether)/polystyrene blend of claim 10 wherein the first mixture further comprises a nucleating agent.

15. The expanded poly (arylene ether)/polystyrene blend of claim 10, wherein the first mixture further comprises an impact modifier.

16. The expanded poly (arylene ether)/polystyrene blend of claim 10, wherein the blowing agent comprises a pentane isomer or a mixture of pentane isomers.

17. An expandable poly(arylene ether)/polystyrene blend comprising poly(arylene ether) resin, polystyrene resin essentially free of plasticizer, a nucleating agent and blowing agent.

18. The expandable poly (arylene ether)/polystyrene blend of claim 17 wherein the poly(arylene ether) has an intrinsic viscosity of about 0.1 to about 0.6 deciliters per gram as measured in chloroform at 25° C.

19. The expandable poly (arylene ether)/polystyrene blend of claim 17 wherein the poly(arylene ether) is present in an amount of about 5 to about 95 weight percent, based on the weight of the composition and the amount of polystyrene is about 5 to about 95 weight percent, based on the weight of the composition.

20. The expandable poly (arylene ether)/polystyrene blend of claim 17 wherein the polystyrene has a molecular weight less than or equal to about 240,000 atomic mass units.

21. The expandable poly (arylene ether)/polystyrene blend of claim 17, further comprising an impact modifier.

22. The expandable poly (arylene ether)/polystyrene blend of claim 17, wherein the blowing agent comprises a pentane isomer or a mixture of pentane isomers.

23. A non-halogenated, fire retardant, expandable poly(arylene ether)/polystyrene blend comprising poly(arylene ether) resin, polystyrene resin essentially free of plasticizer, a non-halogenated fire retardant, a nucleating agent and blowing agent.

24. The non-halogenated, fire retardant, expandable poly (arylene ether)/polystyrene blend of claim 23 wherein the poly(arylene ether) has an intrinsic viscosity of about 0.1 to about 0.6 deciliters per gram as measured in chloroform at 25° C.

25. The non-halogenated, fire retardant, expandable poly (arylene ether)/polystyrene blend of claim 23 wherein the poly(arylene ether) is present in an amount of about 5 to about 95 weight percent, based on the weight of the composition and the amount of polystyrene is about 5 to about 95 weight percent, based on the weight of the composition.

26. The non-halogenated, fire retardant, expandable poly (arylene ether)/polystyrene blend of claim 23 wherein the polystyrene has a molecular weight less than or equal to about 240,000 atomic mass units.

27. The non-halogenated, fire retardant, expandable poly (arylene ether)/polystyrene blend of claim 23, further comprising an impact modifier.

28. The non-halogenated, fire retardant, expandable poly (arylene ether)/polystyrene blend of claim 23, wherein the blowing agent comprises a pentane isomer or a mixture of pentane isomers.

29. The non-halogenated, fire retardant, expandable poly (arylene ether)/polystyrene blend of claim 23, wherein the non-halogenated fire retardant comprises butylated triphenyl phosphate ester, resorcinol tetraphenyl diphosphate, bis-phenol A tetraphenyl diphosphate, or a mixture of two or more of the foregoing

30. An expandable poly(arylene ether)/polystyrene blend produced by the method comprising:
in a first step, forming a first mixture comprising poly(arylene ether) resin and polystyrene resin essentially free of plasticizer, by intimately mixing in melt; and
in a second step forming an expandable poly(arylene ether)/polystyrene blend by intimately mixing in melt the first mixture with a blowing agent.

31. The expandable poly (arylene ether)/polystyrene blend of claim 30 wherein the poly(arylene ether) has an intrinsic viscosity of about 0.1 to about 0.6 deciliters per gram as measured in chloroform at 25° C.

32. The expandable poly (arylene ether)/polystyrene blend of claim 30 wherein the poly(arylene ether) is present in an amount of about 5 to about 95 weight percent, based on the weight of the composition and the amount of polystyrene is about 5 to about 95 weight percent, based on the weight of the composition.

33. The expandable poly (arylene ether)/polystyrene blend of claim 30 wherein the polystyrene has a molecular weight less than or equal to about 240,000 atomic mass units.

34. The expandable poly (arylene ether)/polystyrene blend of claim 30, further comprising an impact modifier.

35. The expandable poly (arylene ether)/polystyrene blend of claim 30, wherein the blowing agent comprises a pentane isomer or a mixture of pentane isomers.

36. The expandable poly (arylene ether)/polystyrene blend of claim 30 wherein the first mixture further comprises a nucleating agent.

37. A non-halogenated, fire retardant expandable poly(arylene ether)/polystyrene blend produced by the method comprising:
in a first step, forming a first mixture comprising poly(arylene ether) resin, polystyrene resin essentially free of plasticizer, and a non-halogenated fire retardant by intimately mixing in melt; and
in a second step forming an expandable poly(arylene ether)/polystyrene blend by intimately mixing in melt the first mixture with a blowing agent.

38. The non-halogenated, fire retardant, expandable poly (arylene ether)/polystyrene blend of claim 37 wherein the poly(arylene ether) has an intrinsic viscosity of about 0.1 to about 0.6 deciliters per gram as measured in chloroform at 25° C.

39. The non-halogenated, fire retardant, expandable poly (arylene ether)/polystyrene blend of claim 37 wherein the poly(arylene ether) is present in an amount of about 5 to about 95 weight percent, based on the weight of the composition and the amount of polystyrene is about 5 to about 95 weight percent, based on the weight of the composition.

40. The non-halogenated, fire retardant, expandable poly (arylene ether)/polystyrene blend of claim 37 wherein the polystyrene has a molecular weight less than or equal to about 240,000 atomic mass units.

41. The non-halogenated, fire retardant, expandable poly (arylene ether)/polystyrene blend of claim 37 wherein the fire retardant mixture further comprises a nucleating agent.

42. The non-halogenated, fire retardant, expandable poly (arylene ether)/polystyrene blend of claim 37, wherein the fire retardant mixture further comprises an impact modifier.

43. The non-halogenated, fire retardant, expandable poly (arylene ether)/polystyrene blend of claim 37, wherein the non-halogenated fire retardant comprises butylated triphenyl phosphate ester, resorcinol tetraphenyl diphosphate, bis-phenol A tetraphenyl diphosphate, or a mixture of two or more of the foregoing.

44. The non-halogenated, fire retardant, expandable poly (arylene ether)/polystyrene blend of claim 37, wherein the blowing agent comprises a pentane isomer or a mixture of pentane isomers.

45. A precursor composition useful in making an expandable poly(arylene ether)/polystyrene composition comprising poly(arylene ether) resin, a polystyrene resin essentially free of plasticizer and a nucleating agent.

46. The precursor composition of claim 45 wherein the poly(arylene ether) has an intrinsic viscosity of about 0.1 to about 0.6 deciliters per gram as measured in chloroform at 25° C.

47. The precursor composition of claim 45 wherein the poly(arylene ether) is present in an amount of about 5 to about 95 weight percent, based on the weight of the composition and the amount of polystyrene is about 5 to about 95 weight percent, based on the weight of the composition.

48. The precursor composition of claim 45 wherein the polystyrene has a molecular weight less than or equal to about 240,000 atomic mass units.

49. The precursor composition of claim 45, further comprising an impact modifier.

50. The precursor composition of claim 45, wherein the blowing agent comprises a pentane isomer or a mixture of pentane isomers.

51. The precursor composition of claim 45 further comprising a non-halogenated fire retardant.

52. A non-halogenated, fire retardant, expandable poly (arylene ether)/polystyrene blend produced by the method comprising:
in a first step, melt mixing independent components comprising a non-halogenated fire retardant, poly(arylene ether) resin, and a polystyrene resin essentially free of plasticizers to form a fire retardant mixture;
in a second step, forming a non-halogenated, fire retardant, expandable poly (arylene ether)/polystyrene blend by intimately mixing in melt the fire retardant mixture with a blowing agent.

53. An expandable poly(arylene ether)/polystyrene blend produced by the method comprising:
in a first step, melt mixing independent components comprising poly(arylene ether) resin and polystyrene resin essentially free of plasticizer by intimately mixing to form a first mixture; and
in a second step forming an expandable poly(arylene ether)/polystyrene blend by intimately mixing in melt the first mixture with a blowing agent.
